(19) United States
(12) Patent Application Publication
(10) Pub. No.: US 2009/0157436 A1
(43) Pub. Date: Jun. 18, 2009

(54) REVENUE CYCLE SYSTEM AND METHOD

(76) Inventor: Bruce Craycraft, Marietta, GA (US)

Correspondence Address: VEDDER PRICE P.C., 222 N. LASALLE STREET, CHICAGO, IL, 60601, US

(21) Appl. No.: 12/334,787

(22) Filed: Dec. 15, 2008

Related U.S. Application Data
(60) Provisional application No. 61/013,882, filed on Dec. 14, 2007.

(51) Int. Cl. G06Q 40/00; G06F 17/30; G06F 17/40; G06Q 30/00

(52) U.S. Cl. 705/4; 707/104.1; 707/100; 705/30; 707/E17.044

(57) ABSTRACT

A revenue cycle system includes a payment status module and an activity status module. The payment status module provides payment status information for a plurality of insurance claims payment information and a plurality insurance providers. The payment status information is based on payment information. The payment information includes an amount paid and payment timing information. The activity status module provides activity status information based on billing staff activity information, account follow-up staff activity information, and/or payer feedback information, generally derived from software algorithms which identify revenue cycle activities represented by freeform notations recorded on an account.

### FIELD

The present disclosure generally relates to third party payment systems, and more particularly, systems and methods to improve revenue cycle operations associated with third party payment systems.

### BACKGROUND

Health care providers typically obtain payment for health care services from third party payers, such as health insurers. In order to obtain payment from third party payers, health care providers use patient records including information regarding each health care service provided to the patient. The entire process of gathering relevant information, along with submitting claims for payment to third party payers and the follow-up on such claims to insure they are paid, is a substantial portion of overall revenue cycle operations. When third party payers pay less than the full amount due, health care providers currently rely on manual follow-up procedures to obtain additional payments. Imperfections in identifying inaccurately paid claims and in the requisite remedial follow-up procedures can result in failure by health care providers to follow-up on a significant number of inaccurately paid claims. In addition, health care provider follow-up procedures can take significant time, which increases costs and aggravates patients. Furthermore, health care providers can suffer losses by continuing to provide services under circumstances that result in inaccurately reduced claim payments by third party payers.

Accordingly, it is desirable, among other things, to provide a system and method that is capable of identifying claims that have not been properly paid by a third party payer and to provide improved follow-up procedures without the aforementioned drawbacks.

### BRIEF DESCRIPTION OF THE DRAWINGS

The disclosure will be more readily understood in view of the following description when accompanied by the below figures, wherein like reference numerals represent like elements:

FIG. 1 is a block diagram of a device that may be used to implement processing in accordance with various embodiments of the present disclosure;

FIG. 2 is a block diagram of a revenue cycle system in accordance with one embodiment of the present disclosure;

FIG. 3 is a flowchart depicting exemplary operations that can be performed by the revenue cycle system in accordance with one embodiment of the present disclosure; and

FIG. 4 is a flowchart depicting additional exemplary operations that can be performed by the revenue cycle system in accordance with one embodiment of the present disclosure.

### SUMMARY

Among other advantages, the system and methods described herein identify specific opportunities for improving financial results from insurance claims processing and revenue cycle operations by healthcare providers. The system and method can improve financial results by identification of: claims that appear to have become lost, claims that are paid but have been underpaid and/or overpaid, claims paid in full that experienced excessive re-work, and claims that were not paid by the payer. As such, the identified categories can be used by healthcare providers to prioritize claim follow-up procedures and/or to reclassify claims to improve revenue cycle operations. Other advantages will be recognized by those of ordinary skill in the art.

In one embodiment, a revenue cycle system is provided that includes a payment status module and an activity status module. The payment status module provides payment status information for a plurality of insurance claims and a plurality of insurance providers based on payment information. The payment information may include an amount paid and payment timing information. The activity status module provides activity status information based on billing staff activity information, account follow-up staff activity information, and/or payer feedback information. This information can be derived from freeform notes entered on the patient account by billing and/or account follow-up personnel or text entries that are generated by a claim generation system. A related method is also disclosed.

In another embodiment, the revenue cycle system includes a payment anomaly module. The payment anomaly module determines payment anomaly information for each of the insurance claims based on the payment status information. The payment anomaly information indicates whether an insurance claim has been underpaid, overpaid, and/or lost.

In yet another embodiment, the revenue cycle system includes a reworked payment module. The reworked payment module determines which of the insurance claims have been paid in full based on the amount paid. In addition, the reworked payment module determines time lapse information for each of the insurance claims paid in full based on a billing date and a payment date. Furthermore, the reworked payment module classifies each of the insurance claims as reworked insurance claims based on the time lapse information and various types of rework activities derived from freefrom notes entered on the account by billing staff, follow-up staff, and/or claim generation system notes. Each insurance claim category can then be ranked based on the average time lapse.

In still another embodiment, the revenue cycle system may include a refused payment module. The refused payment module determines which of the insurance claims have been refused payment based on the payment status information and the activity status information. In addition, the refused payment module classifies each of the insurance claims that have been refused payment into a plurality of refused insurance claim categories.

### DETAILED DESCRIPTION

As used herein, the term module can include an electronic circuit, one or more processors (e.g., shared, dedicated, or group of processors such as but not limited to microprocessors, digital signal processors, or central processing units) and memory, that execute one or more software or firmware programs, combinational logic circuits, an application specific integrated circuit (ASIC), other suitable components that provide the described functionality, or any suitable commendation thereof.

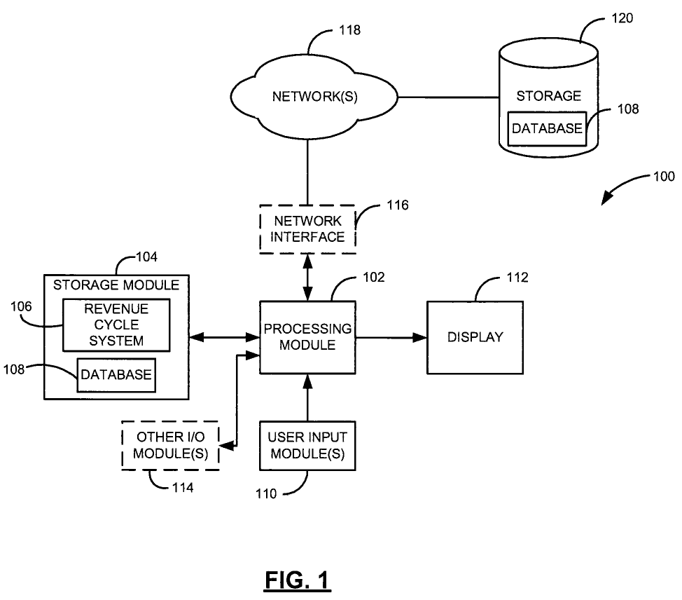

Referring now to FIG. 1, an exemplary device 100 that can be used in accordance with the present disclosure is depicted. In one embodiment, the device 100 may comprise a suitably programmed server computer; desktop, laptop or handheld computer or the like. Regardless of its particular implementation, the device 100 can include a processing module 102 operatively coupled to a storage module 104. The storage module 104 includes a revenue cycle system 106 and an associated database 108, both described in further detail below. The processing module 102 can include one or more processing devices such as a microprocessor, microcontroller, digital signal processor or combinations thereof capable of executing instructions associated with the revenue cycle system 106 and operating upon the database 108. Likewise, the storage module 104 can include one or more storage devices such as volatile or non-volatile memory including random access memory (RAM), read-only memory (ROM), electrically-erasable programmable read-only memory (EEPROM), and/or other suitable storage devices. Those having ordinary skill in the art will appreciate that various other suitable arrangements of the processing module 102 and storage module 104 may be readily devised in accordance with the present disclosure.

In one embodiment, the device 100 can include one or more user input module(s) 110, a display 112, other input/output module(s) 114, and/or a network interface module 116, each in communication with the processing module 102. The user input module(s) 110 can be any known mechanism for providing user input to the processing module 102. For example, the user input module(s) 110 can include a keyboard, a mouse, a touch screen, stylus and/or any other suitable means known to those having ordinary skill in the art whereby a user of the device 100 may provide input data to the processing module 102. The display 112 can include any conventional display mechanism such as a cathode ray tube (CRT), a flat panel display, a liquid crystal (LCD) display, a light emitting diode (LED) display, plasma display, and/or any other suitable display mechanism known to those having ordinary skill in the art. Techniques for providing display data from the processing module 102 to the display 112 are well known in the art.

The other (optional, as illustrated by the dashed lines) input/output module(s) 114 can include various media drives (such as magnetic disc or optical disc drives), a microphone or any other source of input data or selection indications, as well as other devices capable of providing information to a user of the device 100, such as speakers, LEDs, tactile outputs, and other suitable devices.

The network interface module 116 can include hardware and/or software that allows the processing module 102 to communicate with other devices via a wired and/or wireless network(s) 118, as known in the art. The network(s) 118 comprise any suitable communication network such as the World Wide Web, the Internet, Ethernet, WiFi, and/or IEEE 802.11 for example. The network interface module 116 can be any suitable network interface capable of interacting with the network(s) such as, for example, an Ethernet interface, USB interface, and/or a wireless interface.

Using the network interface module 116, the techniques of the present disclosure can be performed in a remote manner, for example, as in the case of a Web application service. In one embodiment, the processing enabled by the device 100 may be performed at the request of another device (not shown) communicating with the device 100 via the network(s) 118 and the network interface 116. In addition, in some embodiments, the database 108 can be stored in a remote storage module 120, which is in communication with the device 100 via the network(s) 118. The remote storage module 120 can be any suitable database server with appropriate software such as a database management system (DBMS) for example.

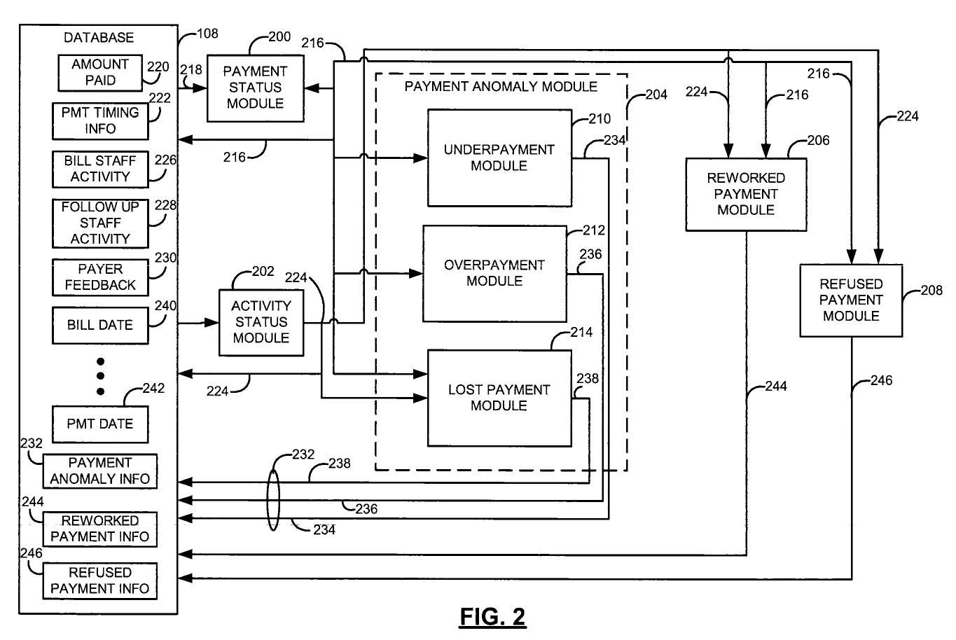

Referring now to FIG. 2, an exemplary functional block diagram of the revenue cycle system 106 is depicted. The revenue cycle system 106 includes a payment status module 200, an activity status module 202, a payment anomaly module 204, a reworked payment module 206, and a refused payment module 208 configured as shown. In addition, the payment anomaly module 204 includes an underpayment module 210, an overpayment module 212, and a lost payment module 214. Although shown as multiple modules, skilled artisans will appreciate that one or more of the modules can be combined if desired.

During operation, the payment status module 200 provides payment status information 216 for a plurality of insurance claims and a plurality of insurance providers based on payment information 218 that includes an amount paid 220 and payment timing information 222. The activity status module 202 provides activity status information 224 based on billing staff activity information 226, account follow-up staff activity information 228, and/or payer feedback information 230. Once provided, the payment status information 216 and the activity status information 224 can be populated in the database 108 (not shown) for future use.

The payment anomaly module 204 can determine payment anomaly information 232 for each of the plurality of insurance claims based on the payment status information 216 and/or activity status information 224. Once determined, the payment anomaly information 232 can be populated in the database 108.

The payment anomaly information 232 can include, among other things, underpayment information 234, overpayment information 236, lost payment information 238, and/or other suitable information. In one embodiment, the underpayment module 210 provides the underpayment information 234 based on the payment status information 216. The overpayment module 212 provides the overpayment information 236 based on the payment status information 216. The lost payment module 214 provides the lost payment information 238 based on the payment status information 216 and the activity status information 224.

The underpayment information 234 can include, among other things, status that a claim has been underpaid, one or more underpayment follow-up procedures that can be used by account follow-up staff to improve the revenue cycle of insurance claim payments, and/or other suitable information. For example, in one embodiment, the underpayment follow-up procedures can include a ranking of insurance claim types by most (or least) occurrences of underpayment and/or most (or least) amount of underpayment. As such, account follow-up staff can utilize their efforts more efficiently when following up on underpaid claims to target claims most likely to result in payment.

Similarly, the overpayment information 236 can include, among other things, status that a claim has been overpaid, one or more overpayment follow-up procedures that can be used by account follow-up staff to improve the revenue cycle of insurance claim payments, and/or other suitable information. For example, in one embodiment, the overpayment follow-up procedures can include a ranking of insurance claims by most (or least) occurrences of overpayment and/or most (or least) amount of overpayment. As such, account follow-up staff can utilize their efforts more efficiently when following up on overpaid insurance claims to determine the necessity to generate a refund or to correct a payment posting error.

Likewise, the lost payment information 238 can include, among other things, status that a claim has not been paid for a particular period of time and therefore has become lost (e.g., a lost payment), one or more follow-up procedures that can be used by account follow-up staff to improve the revenue cycle of insurance claim payments, and/or other suitable information. For example, in one embodiment, the lost payment follow-up procedures can include a ranking of insurance claims by most (or least) occurrences all of lost payments and/or most (or least) amount of time lapse to prior to receiving payment. As such, account follow-up staff can utilize their efforts more efficiently when following up on insurance claims to target claims most likely to result in payment. Furthermore, if for example, the majority of lost payment claims are for a particular type of claim, then the follow-up staff can focus on these categories; e.g., a particular claim balance range for a particular third party payment.

The reworked payment module 206 determines which of the plurality of insurance claims have been paid in full and a time lapse until full payment based on the payment status information 216. More specifically, the reworked payment module 206 determines which claims have been paid in full based on the amount paid 220 and determines the time lapse based on a billing date 240 and a payment date 242. In addition, the reworked payment module 206 can determine an amount of rework staff activity required to achieve payment based on the activity status information 224. The reworked payment module 206 then classifies the insurance claims that have been paid in full as reworked insurance claims based on the time lapse until full payment and an amount of rework staff activity. The reworked payment module 206 can also populate the reworked payment information 244 in the database 108. The reworked payment information 244 can include, among other things, status that a claim has been reworked, how much time has lapsed during the reworked period, a ranking of most (or least) reworked insurance claim types, a ranking of most (or least) staff rework activity, and/or other suitable information. As such, management personnel of the healthcare provider using the revenue cycle system 106 can utilize their efforts more efficiently when targeting process improvement efforts to reduce the amount of staff rework required to achieve claim payment

The refused payment module 208 determines which of the plurality of insurance claims have been refused payment based on the payment status information 216 and the activity status information 224 and provides refused payment information 246 based thereon. The refused payment information 246 can be stored in the database 108 if desired. In some embodiments, the refused payment module 208 classifies the insurance claims that have been refused payments into a plurality of refused insurance claim categories. The refused payment information 246 can include, among other things, status that a claim has been refused payment, a ranking of most (or least) refused to insurance claim types, and/or other suitable information. As such, account follow-up staff can utilize their efforts more efficiently when following up on insurance claims to target claims most likely to result in payment. Furthermore, if for example, an insurance claim falls into multiple categories: a category that results in a refused claim payment, a category that results in a reworked payment, a category that results in an underpayment, and/or a category that results in an overpayment; the follow-up staff can reclassify claims from the refused category into the reworked category, the overpayment category, and/or the underpayment category to improve the revenue cycle of insurance claim payments.

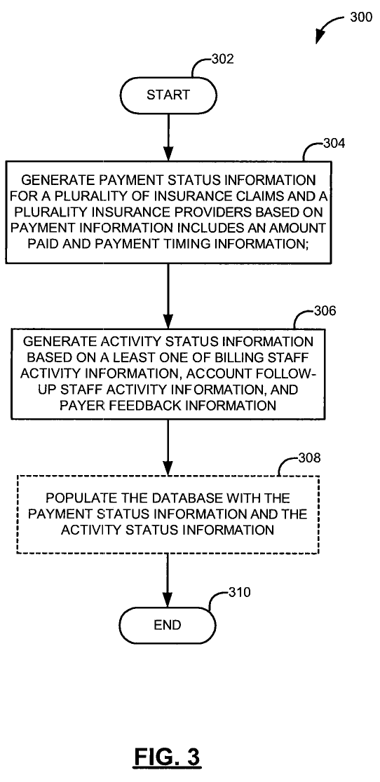

Referring now to FIG. 3, exemplary operations that can be performed by the revenue cycle system 106 are generally identified at 300. The process starts at 302. At 304, the payment status module 200 generates the payment status information 216 for a plurality of insurance claims and a plurality of insurance providers based on the payment information 218. For example, in one embodiment, the payment status module 200 can categorize the plurality of insurance claims and provide an average amount paid and average timing information for each category in order to provide the payment status information 216. As previously noted, the payment status information 218 can include an amount paid 220 and payment timing information 222. At 306, the activity status module 202 provides the activity status information 224 based on billing staff activity information 226, account follow-up staff activity information 228, and/or payer feedback information 230. In one embodiment, the activity status module 202 provides the activity status information 218 in response to changes of the billing staff activity information 226, account follow-up staff activity information 228 and/or payer feedback information 230. For example, the activity status module 202 can determine whether any new information has been included in the billing staff activity information 226, account follow-up staff activity information 228 and/or payer feedback information 230 and provide the activity status information based thereon. In some embodiments, the database 108 can be populated with the payment status information 216 and the activity status information 224 at 308. The process ends at 310.

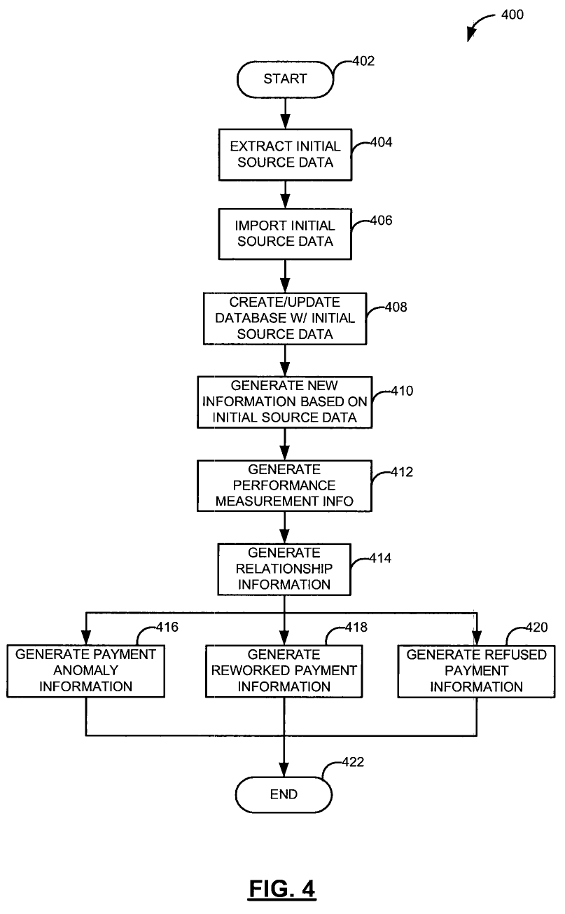

Referring now to FIG. 4, additional exemplary operations that can be performed by the revenue cycle system 106 are generally identified at 400. The process starts at 402. At 404, the revenue cycle system 106 extracts initial source data from an existing healthcare provider information system (not shown) that includes patient accounting, billing, insurance claim generation, billing staff activity, follow-up staff activity, and/or other suitable revenue cycle management functions. Exemplary initial source data that can be obtained from the existing healthcare provider information system is identified in Appendix A. Techniques for extracting such data are well known in the art.

At 406, the revenue cycle system 106 imports the initial source data extracted from the healthcare provider information system. More specifically, the revenue cycle system 106 examines the initial source data and edits, reformats, and/or translates the initial source data in preparation for loading it into the database 108. For example, the revenue cycle system 106 may edit, reformat, and/or translate, the initial source data into a particular format (e.g., currency, date, numeric, boolean, text, etc.). In one embodiment, the initial source data can include reference information such as health insurance plan information, staff user name information, financial class information, clinical service location information, claims status information, primary care physician information, admitting physician information, attending physician information, and/or other suitable information identified in Appendix B.

In addition, in some embodiments, the initial source data can include patient information for each individual patient such as, for example, demographic information, health insurance coverage information, financial status information, clinical summary information, and/or other suitable patient information identified in Sub Table 1.1 of Appendix A.

Furthermore, in some embodiments, the initial source data can include transactional information that is recorded for each particular patient. Exemplary transactional information includes payment information, adjustment information, refund information, claims generated information (e.g., final bills), billing staff activities, account follow-up staff activities, billing staff comments, account follow-up staff comments, insurance priority sequence maintenance information, payer claim status information, payer denial information, claim payment reconsideration information, and/or other suitable information identified in Sub Table 1.1 of Appendix A.

At 408, the revenue cycle system 106 creates and/or updates the database 108 with the initial source data subsequent to the preparation noted above. For example, the revenue cycle system 106 can read, process, and/or load the database 108 with demographic information, insurance information, financial status information, clinical summary information, financial transaction information, claim status information, claim denial information, billing staff activity information and comments, account follow-up staff activity information and comments, status of insurance claims generated (e.g., final bills), claims reconciliation information, and/or other suitable information.

At 410, the revenue cycle system 106 generates new information based on the initial source data. For example, as previously noted, in one embodiment, the payment activity module 200 generates payment status information 216 based on the payment information 218, which can include, among other things, an amount paid 220 and payment timing information 222. The payment status information 216 can be used to summarize activities for each insurance payer with respect to an individual patient's (or guarantor's) payments. As such, the revenue cycle system 106 can use the payment status information 216 to assess, among other things, sufficiency of payments, time frames of payments, the intensity and content involved in reworking payments, and/or other suitable information identified in Appendix C. For example, by correlating claim filing data, payment posting data, and follow-up staff activity derived from freeform notes, the revenue cycle system 106 can identify claims due for payment which are no longer experiencing active follow-up and are likely to never be paid unless renewed attention is brought to the unpaid claim. Further, the revenue cycle system 106 identifies claims which are recorded as having been paid, but the payment amount is most likely inaccurate. These inaccurately paid claims can be brought to the attention of the healthcare provider for correction.

In addition, as previously noted, the activity status module 202 generates activity status information 224 based on billing staff activity information, account follow-up staff activity information, payer feedback information, and/or other suitable information. As such, the revenue cycle system 106 can use the activity status information 224 to assess, among other things, adjustment activities for each insurance payer with respect to a particular patient's (or guarantor's) payment adjustments, sufficiency of any associated payments, time frames of payment adjustments, claim follow-up event information, and/or other suitable information identified in Appendix D. For example, the revenue cycle system 106 determines how many claim re-submissions were made prior to receiving payment. Further, the revenue cycle system 106 identifies the frequency and operational nature of the billing and/or follow-up staff activities associated with achieving final payment.

The revenue cycle system 106 can also generate claim status information and claim denial information based on the initial source data. In some cases, claim denials are not posted as a financial adjustment transactions. As such, the revenue cycle system utilizes its activity status module 202 to determine from freeform entries when a third party payer has communicated that a claim is going to be denied. Accordingly, the healthcare provider can use this information to pursue a reversal of the denied claim.

The revenue cycle system 106 can assess, among other things, claim follow-up event rework information, events that caused the rework, and/or other suitable information identified in Appendix E based on the claim status information and/or claim denial information. For example, if a third party payer requests validation that a family member over 21 years of age is a full-time student, and therefore eligible for coverage on the parent's insurance plan, the revenue cycle system 106 examines the freeform notes and determines when a third party payer has requested such information, the frequency of such requests, and the particular clinical services that experience the majority of these requests. Therefore, the revenue cycle system 106 provides performance improvement information based on the claim status information.

Similarly, the revenue cycle system 106 can generate billing staff activity and comment information. For example, by examining billing and/or and follow-up personnel freeform notes, the revenue cycle system 106 can interpret the freeform notes to derive billing staff activity information; e.g., the claim had to be re-billed due to missing accident information on the claim for a patient treated for an accident. As such, the revenue cycle system 106 can assess, among other things, the extent of billing and rebilling associated with receiving final payment for insurance claim and/or other suitable information identified in Appendix F. For example, the revenue cycle system 106 accumulates the volume and categories of billing staff activity and comment information to provide information regarding which billing rework activities are most prevalent and the types of rework activities which are most prevalent.

Likewise, the revenue cycle system 106 can generate account follow-up staff activity and comment information. As such, the revenue cycle system 106 can assess, among other things, the extent of follow-up activities associated with receiving final payment and/or other suitable information identified in Appendix G.

At 412, the revenue cycle system 106 generates performance measurement information based on the initial source data and the new information generated at 410. More specifically, the revenue cycle system 106 analyzes the initial source data and the new information generated at 410 to provide the performance measurement information. The performance measurement information can include, among other things, the payment status information 216, the activity status information 224, and/or other suitable information identified in Appendix H. In one embodiment, the revenue cycle system 106 can compare information included in the performance measurement information such as an amount billed and an amount paid in order to determine whether an amount paid is appropriate (or appears to be appropriate), an underpayment, an overpayment, and/or experienced rework in the process of finalizing payment. For example, the performance measurement can include a percentage of claims paid without manual intervention (i.e., rework) from the initial claim submission. This “clean claim” status is determined by the revenue cycle system 106 evaluating the freeform notes entered on a patient's account along with payment activity and making a determination as to whether the claim was paid without manual intervention (“clean claim”) or had to be reworked.

In addition, the revenue cycle system 106 can utilize the performance measurement information to assess, among other things, activities that provide evidence of rework activities to receive the final payment for an insurance claim. For example, the revenue cycle system 106 determines from the freeform notes when a third party payer has requested additional information in order to adjudicate and/or pay the claim. The activity status module 202 identifies these requests and by examination of the freeform entries can determine when the information was sent to the third party payer. As an example, the “clean claim” performance can be reported to various clinical service locations within a healthcare provider's operation and having differences in “clean claim” performance levels identified.

At 414, the revenue cycle system 106 generates relationship information that summarizes relationships between the various performance measurement information generated at 412. Exemplary relationship information that can be summarized based on the performance measurement information is identified in Appendix J.

At 416, the payment anomaly module 204 determines the payment anomaly information 232 based on the payment status information 216 and/or the activity status information 224. As previously noted, the payment anomaly information 216 includes underpayment information 234, overpayment information 236, and/or lost payment information 238.

The lost payment module 214 determines the lost payment information 238 based on the activity status information 224 and the payment status information 216. More specifically, the lost payment module 214 can determine the lost payment information 213 when an insurance claim appears to be valid and has not had any financial, payer, billing staff, or account follow-up staff activity for an extended period of time, such as 40 days for example. In addition, the lost payment module 214 can group claims by payer and by follow-up methods available for each claim, such as for example, online follow-up methods, telephonic follow-up methods, and/or other suitable follow-up methods. As such, the lost payment module 214 can determine an average percentage paid for similar claims, which can be applied to the outstanding claims to estimate an expected payment amount. In addition, the lost payment module 214 can assess the likelihood of receiving payment for similar claims. The likelihood can be determined by analyzing historical results of payments obtained. Furthermore, the lost payment module 214 can rank the payment expected and/or likelihood of receiving payment in order to establish a prioritized lost payment follow-up procedure.

The underpayment module 210 determines the underpayment information 234 based on the payment status information 216. More specifically, the underpayment module 210 can determine the underpayment information when an insurance claim has been paid but the amount receive is less than the amount billed. In addition, the underpayment module 210 can group claims by payer and by follow-up methods available for each claim, such as for example, online follow-up methods, telephonic follow-up methods, and/or other suitable follow-up methods. As such, the underpayment module 210 can determine an average percentage paid for similar claims, which can be applied to the outstanding claims to estimate an expected payment amount. In addition, the underpayment module 210 can assess the likelihood of overturning a stated reasoning for a lower payment received for similar claims. The likelihood can be determined by analyzing historical results of payments obtained for similar types of services. Furthermore, the underpayment module 210 can rank the payment expected and/or likelihood of receiving payment in order to establish a prioritized underpayment follow-up procedure.

Similarly, the overpayment module 212 determines the overpayment information 238 based on the payment status information 216. As such, the overpayment module 212 can assess the likelihood of receiving an overpayment for similar claims. The likelihood can be based determined by analyzing historic results of payments obtained for similar types of services. Furthermore, the overpayment module 212 can rank the payment expected and/or likelihood of receiving payment in order to establish a prioritized overpayment follow-up and/or refund procedure.

The revenue cycle system 106 can then provide the prioritized lost payment follow-up procedure, prioritized underpayment follow-up procedure, and prioritized overpayment follow-up procedure to a healthcare provider in any suitable manner, such as for example, via the display 108. Alternatively, printed reports may be provided. Accordingly, the health care provider can use the follow-up procedures to pursue claims that are likely to be fully paid in a timely manner followed by claims that are less likely to be paid in full and/or paid in a timely manner.

At 418, the reworked payment module 206 provides the reworked payment information 244 based on the payment status information 216 and the activity status information 224. The reworked payment information 244 can include, among other things, the average number of days to reach final payment, the types of rework activities involved, and the intensity of rework activities involved. More specifically, the reworked payment module 206 determines which claims have been paid in full based on the amount paid 220 and determines time lapse information for each of the claims based on the billing date 240 and the payment date 242. In addition, the reworked payment module 206 determines an average time lapse and amount paid for each payer and an average time lapse and amount paid for a plurality of types of claims for that particular payer. The reworked payment module 206 analyzes the average time lapses to determine the amount of rework required for the plurality of types of claims for each payer. As such, the reworked payment module 206 can rank the plurality of claims based on the average time lapses and the average amount paid in order to provide a prioritized rework follow-up procedure in order to reduce the rework required and the average time lapse until payment. The prioritized reworked follow-up procedure can then be communicated to a healthcare provider via any suitable method such as, for example, via the display 108 or via hardcopy reports.

At 420, the refused payment module 208 provides refused payment information 246 based on the payment status information 216 and the activity status information 224. The refused payment module 208 examines the contents of a database 108 to determine which claims each payer has permanently refused to pay. For example, the refused payment module 208 analyzes operational activities that occurred to the refused claims prior to payment being permanently refused. The operational activities can include, among other things, billing staff activity, account the follow-up staff activity, whether the patients visit was scheduled, pre-certified, or an emergency, and/or other suitable information. In addition, the refused payment module 208 can compare claims paid in full for patients with the same insurance coverage (e.g., the same payer) and who received similar clinical services. In this manner, a refused payment follow procedure can be determined based on payments of similar claims that were paid in full which can be used to reduce the number of permanently refused claims. The refused payment follow procedure can be communicated to a healthcare provider via any suitable means such as, for example, via the display 108 or printed reports. The process ends at 422.

As noted above, among other advantages, the revenue cycle system 106 and related method identify specific opportunities for improving financial results from insurance claims processing and revenue cycle operations by healthcare providers. The system and method can improve financial results by identification of: claims that appear to have become lost, claims that are paid but have been underpaid and/or overpaid, claims paid in full that experienced excessive re-work, and claims that were permanently refused by the payer. As such, the identified categories can be used by healthcare providers to prioritize claim follow-up procedures and/or to reclassify claims to improve revenue cycle operations. Other advantages will be recognized by those of ordinary skill in the art.

While this disclosure includes particular examples, it is to be understood that the disclosure is not so limited. Numerous modifications, changes, variations, substitutions, and equivalents will occur to those skilled in the art without departing from the scope of the present disclosure upon a study of the drawings, the specification, and the following claims.

### Appendix A

### Table 1

The following data table represents an exemplary set of data requested from a healthcare provider. In this example, the data from the provider includes master account information and multiple types of detail transaction entries. Each of these classifications are shown in sub-table 1.1 through sub-table 1.7. In some instances, the healthcare provider may be able to provide more or less information than the exemplary data shown below.

SUB-TABLE 1.1

| Description of the data | | Value if data field |
|---|---|---|
| field | Edit Rules | empty |
| DEMOGRAPHIC | The following fields are of a demographic | |
| | nature | |
| Facility id which uniquely | Any alphanumeric value | Required field |
| identifies the provider to the | | |
| invention | | |
| Patient Account Number | Any alphanumeric value | Required field |
| assigned by the provider to | | |
| uniquely represent this | | |
| episode of clinical care | | |
| Patient First Name | Alpha | Optional |
| Patient Last Name | Alpha | 1^{st} letter of last name is |
| | | required |
| Patient Date of Birth | Date format | A “space” if date missing |
| Patient Address City | Alpha | A “space” if missing |
| Patient Address State | Alpha | A “space” if missing |
| Guarantor First Name | Alpha | A “space” if missing |
| Guarantor Last Name | Alpha | A “space” if missing |
| Guarantor Employer | Alpha | A “space” if missing |
| Patient Sex | One alphanumeric character | A “space” if missing |
| FINANCIAL | The following fields are of a financial nature | |
| Total Charges for this | Currency format | $0.00 if input data |
| episode of care | | missing |
| Total Adjustments for this | Currency format | $0.00 if input data |
| episode of care | | missing |
| Total Payments for this | Currency format | $0.00 if input data |
| episode of care | | missing |
| Account Balance for this | Currency format | $0.00 if input data |
| episode of care | | missing |
| Insurance Balance total of | Currency format | $0.00 if input data |
| all insurance amounts | | missing |
| pending for this episode of | | |
| care | | |
| Patient Balance pending for | Currency format | $0.00 if input data |
| this episode of care | | missing |
| Original Financial Class | An alphanumeric entry | A “space” if missing |
| (see Table 2 for description | | |
| of financial classes) | | |
| Current Financial Class (see | An alphanumeric entry | A “space” if missing |
| Table 2 for description of | | |
| financial classes) | | |
| Original major payer | An alphanumeric entry | A “space” if missing |
| Insurance Plan id Class (see | | |
| Table 2 for description of | | |
| Health Insurance Plans) | | |
| Current major payer | An alphanumeric entry | A “space” if missing |
| Insurance Plan id Class (see | | |
| Table 2 for description of | | |
| Health Insurance Plans) | | |
| Date Insurance Verified by | Date format | A “space” if date missing |
| the payer stating that the | | |
| patient had coverage | | |
| Date pre-certification | Date format | A “space” if date missing |
| obtained for a particular | | |
| service or procedure prior to | | |
| the service being delivered | | |
| Pre-certification number | An alphanumeric entry | A “space” if missing |
| uniquely representing the | | |
| authorization from the | | |
| payer to provide the | | |
| certified clinical service or | | |
| procedure | | |
| Final Bill Date for the | Date format | A “space” if date missing |
| generation of the initial | | |
| primary insurance claim | | |
| form | | |
| Initial claim transmission | Date format | A “space” if date missing |
| date, which is usually the | | |
| same day or one day after | | |
| the final bill date and | | |
| represents the electronic | | |
| transmission of the claim | | |
| data | | |
| Insurance-1 Plan id is the | An alphanumeric entry | A “space” if missing |
| primary (COB = 1) | | |
| insurance (see Table 2 for | | |
| description of Health | | |
| Insurance Plans) | | |
| Insurance-1 Balance | Currency format | $0.00 if input data |
| | | missing |
| Insurance-2 Plan id (see | An alphanumeric entry | A “space” if missing |
| Table 2) | | |
| Insurance-2 Balance | Currency format | $0.00 if input data |
| | | missing |
| Insurance-3 Plan id (see | An alphanumeric entry | A “space” if missing |
| Table 2) | | |
| Insurance-3 Balance | Currency format | $0.00 if input data |
| | | missing |
| Self-Pay plan (no coverage) | An alphanumeric entry | A “space” if missing |
| code | | |
| Self-Pay Balance | Currency format | $0.00 if input data |
| | | missing |
| Last Ins Payment Date | Date format | A “space” if date missing |
| Last Ins Payment Amount | Currency format | $0.00 if input data |
| | | missing |
| Last Patient Payment Date | Date format | A “space” if date missing |
| Last Patient Payment | Currency format | $0.00 if input data |
| Amount | | missing |
| Date the account went to | Date format | A “space” if date missing |
| Zero Balance, if applicable | | |
| CLINICAL | | |
| Date of Pre-Registration or | Date format | A “space” if date missing |
| Date Scheduled | | |
| Admission Date (or earliest | Date format | A “space” if date missing |
| date of service) | | |
| Admission Type | A coded entry, usually related to service, as | |
| | defined for Medicare billing | |
| Admission Source | A coded entry, usually a referral, as defined | |
| | for Medicare billing | |
| Admission Time | Date format | A “space” if date missing |
| Discharge Date (or latest | Date format | A “space” if date missing |
| date of service) | | |
| Discharge Time | Date format | A “space” if date missing |
| Admitting Diagnosis or | Decimal numeric with an optional leading | A “space” if date missing |
| Chief Complaint | alpha, in accordance with Medicare coding | |
| | requirements | |
| Final Diag-1 | Decimal numeric with an optional leading | A “space” if date missing |
| | alpha, in accordance with Medicare coding | |
| | requirements | |
| Final Diag-2 | Decimal numeric with an optional leading | A “space” if date missing |
| | alpha, in accordance with Medicare coding | |
| | requirements | |
| Final Diag-3 | Decimal numeric with an optional leading | A “space” if date missing |
| | alpha, in accordance with Medicare coding | |
| | requirements | |
| Procedure-1 | Decimal numeric, in accordance with | A “space” if data missing |
| | Medicare coding requirements | |
| Procedure-2 | Decimal numeric, in accordance with | A “space” if data missing |
| | Medicare coding requirements | |
| Procedure-3 | Decimal numeric, in accordance with | A “space” if data missing |
| | Medicare coding requirements | |
| Referring Physician | An alphanumeric, Sometimes coded, entry | A “space” if data missing |
| Admitting Physician | An alphanumeric, Sometimes coded, entry | A “space” if data missing |
| Attending Physician | An alphanumeric, Sometimes coded, entry | A “space” if data missing |
| DRG is a code representing | Numeric entry | A “space” if data missing |
| Medicare's definition of | | |
| how to regard this inpatient | | |
| stay | | |
| Patient Type(see Table 2) | An alphanumeric, Sometimes coded, entry | A “space” if data missing |
| Discharge Status | An alphanumeric, Sometimes coded, entry, as | A “space” if data missing |
| | defined for Medicare billing | |
| Accident Date | Date format | A “space” if date missing |
| Accident Code or Type | An alphanumeric, Sometimes coded, entry, as | A “space” if data missing |
| | defined for Medicare billing | |
| Pre-Registrar name or id of | An alphanumeric, Sometimes coded, | A “space” if data missing |
| the person performing this | abbreviated or the initials, entry | |
| function for this patient | | |
| Registrar name or id of the | An alphanumeric, Sometimes coded, | A “space” if data missing |
| person performing this | abbreviated or the initials, entry | |
| function for this patient | | |
| Biller name or id of the | An alphanumeric, Sometimes coded, | A “space” if data missing |
| person performing this | abbreviated or the initials, entry | |
| function for this patient | | |
| Collector name or id of the | An alphanumeric, Sometimes coded, | A “space” if data missing |
| person performing this | abbreviated or the initials, entry | |
| function for this patient | | |
| Clinical Service Location is | An alphanumeric, Sometimes coded, entry | A “space” if data missing |
| the department or part of | | |
| department where the | | |
| clinical service was | | |
| delivered(see Table 2) | | |
| Clinical Service Type | An alphanumeric, Sometimes coded, entry | A “space” if data missing |
| Medical Record Number is | An alphanumeric entry | A required field |
| a unique identifier of the | | |
| medical record for the | | |
| clinical services delivered | | |
| for this billable episode of | | |
| care | | |

2. The following categories of data types are can be generally stored at a “Transaction Level” once the clinical service delivery is complete and the claim form has been generated. The categories are further described in sub-tables 1.2 thru 1.7.

SUB-TABLE 1.2

| | |
|---|---|
| Transaction types of | These transactions all represent changes to the |
| Payment, Adjustment | account balance for an account. |
| or Refund | |
| Facility id | Required |
| Patient Account Number | Required |
| Transaction Date | The effective date of the transaction |
| Transaction Posted Date | The date the transaction was posted to the |
| | account. |
| Transaction Code | A coded entry which further describes the type |
| | of transaction. For example, an adjustment |
| | could be an insurance contractual allowance or |
| | it could be a prompt pay discount for a patient |
| | payment. The transaction code may also |
| | indicate to which insurance plan the transaction |
| | applies. See Table 2 following for additional |
| | detail. |
| Transaction Amount | Currency amount |
| Transaction or Note | This field may be used instead of the |
| Description | transaction code to indicate the insurance plan |
| | for which this transaction applies. |

SUB-TABLE 1.3

| | |
|---|---|
| Transaction type: Claim Denial | These denials may be of the permanent type |
| indicating the insurance plans reply to the | (there will be no payment from the insurance |
| provider as to why the claim is not being | plan) or indefinite. The indefinite denials are |
| paid or is not being paid in full at this time. | sometimes resolved and full payment ensues |
| | and sometimes they are not resolved and no, or |
| | a partial, payment is received for the claim. |
| Facility id | Required Field |
| Patient Account Number | Required Field |
| Transaction Date | The effective date of the transaction |
| Transaction Posted Date | The date the transaction was posted to the |
| | account. |
| Transaction Code | A coded entry which further describes the type |
| | of denial. For example, a denial could be for |
| | non-covered services within an overall claim. |
| | The transaction code may also indicate to |
| | which insurance plan the transaction applies. |
| Transaction Amount | N/A |
| Transaction or Note Description | This field may be used instead of the |
| | transaction code to indicate the insurance plan |
| | for which this denial transaction applies. |

SUB-TABLE 1.4

| | |
|---|---|
| Transaction type: Billing | This transaction type is used to identify when a |
| Activity for an account | Biller has worked on a claim for a patient. |
| | These transactions are usually derived by |
| | scanning freeform comments entered by users |
| | and correlating those entries to users who have |
| | a job function of being a Biller. Alternatively, |
| | in those provider settings where the staff work |
| | on a variety of functions, the transactions are |
| | derived by searching freeform text comments |
| | to determine matches of key words and phrases |
| | which connote an activity a Biller would |
| | perform. See sub-table 2.1 following for |
| | further detail. |
| Facility id | Required |
| Patient Account Number | Required |
| Transaction Date | The effective date of the Biller activity |
| Transaction Posted Date | The date the Biller activity transaction was |
| | posted to the account. |
| Transaction Code | This code is generated to indicate both that the |
| | transaction represents Biller activity and to |
| | include the name or initials of the actual person |
| | who performed the activity. |
| Transaction Amount | N/A for these transactions |
| Transaction or Note | This field contains the first 30 characters of the |
| Description | freeform comment which was entered as part of |
| | this Biller activity. |

SUB-TABLE 1.5

| | |
|---|---|
| Transaction type | This transaction type is used to identify when |
| Claim resolution | an Account Follow-up person has worked on a |
| Follow-Up | claim for a patient. These transactions are |
| Activity for an account | usually derived by scanning freeform |
| | comments entered by users and correlating |
| | those entries to users who have a job function |
| | of performing Follow-up. Alternatively, in |
| | those provider settings where the staff work on |
| | a variety of functions, the transactions are |
| | derived by searching freeform text comments |
| | to determine matches of key words and phrases |
| | which connote an activity a Follow-up person |
| | would perform. See sub-table 2.1 following for |
| | additional detail. |
| Facility id | Required |
| Patient Account Number | Required |
| Transaction Date | The effective date of the Biller activity |
| Transaction Posted Date | The date the Biller activity transaction was |
| | posted to the account. |
| Transaction Code | This code is generated to indicate both that the |
| | transaction represents Account Follow-up |
| | activity and to include the name or initials of |
| | the actual person who performed the activity. |
| Transaction Amount | N/A for these transactions |
| Transaction or Note | This field contains the first 30 characters of the |
| Description | freeform comment which was entered during |
| | this follow-up activity. |

SUB-TABLE 1.6

| | |
|---|---|
| Transaction type: Claim | These transactions are ordinarily generated by |
| Submission of a Final | reviewing system generated audit records to |
| Bill (claim form) to an | identify those records which can be interpreted |
| insurance company. | as being a Final Bill. When these are |
| | identified, the date, the amount of the total |
| | charges billed on the claim, and the plan id are |
| | noted and used below in constructing this |
| | transaction for subsequent processing. |
| Facility id | Required |
| Patient Account Number | Required |
| Transaction Date | The date the Final Bill was produced |
| Transaction Posted Date | The date the Final Bill notation was posted to |
| | the account |
| Transaction Code | This code is created to indicate that a Final Bill |
| | (claim form) has been generated. |
| Transaction Amount | This field represents the total charges included |
| | on the claim form. |
| Transaction or Note | This field usually contains the payer plan name |
| Description | or mnemonic such that the COB entry can be |
| | determined for this claim; i.e. the identity of |
| | the insurance plan for which this claim form |
| | was generated. |

SUB-TABLE 1.7

| | |
|---|---|
| Transaction type | The transaction is used to represent information |
| Payer Claim | which a payer has provided to the provider for |
| Reconciliation | post payment reconciliations. This |
| | circumstance arises when a payer makes an |
| | approximation of the payment amount, pays |
| | that amount, and then subsequently (weeks or |
| | months later) provides the final payment |
| | amount, whether that amount be greater, lesser |
| | or equal to the original payment amount. |
| Facility id | Required |
| Patient Account Number | Required |
| Transaction Date | The effective date of the Settlement or |
| | reconciliation record received from the payer. |
| Transaction Posted Date | The date this transaction was used by the |
| | provider to determine the reconciliation. |
| Transaction Code | A standard code representing one of several |
| | values for reconciliation processing: payment, |
| | an adjustment for a contractual write down by |
| | the payer, a total for non-covered charges, and |
| | the amount of patient responsibility for |
| | deductibles or co-insurance payments. |
| Transaction Amount | The currency value for each of the possible |
| | transaction codes as shown above. |
| Transaction or Note | An optional entry which, when present, |
| Description | contains a short description clarifying why a |
| | certain amount or transaction type was |
| | generated. |

### Appendix B

TABLE 2

| Provider Reference | |
|---|---|
| Files | Description of how the file is used |
| Health Insurance | This file identifies the specific insurance plans used |
| Plan | by patients receiving service from this provider. |
| | The specific information includes, among other |
| | fields, the mnemonic used to identify the plan, the |
| | associated Financial Class, the address where |
| | claims are to be sent, and the phone number to call |
| | to check on the status of a claim. |
| Provider staff user | This file is used to define the operational role of a |
| name | user of the provider's patient accounting system. |
| | In particular, whenever a person is serving as a |
| | Biller or as a Follow-Up representative is used by |
| | the invention. |
| Financial Classes | The file contains the financial class codes and their |
| | descriptions. The primary codes used by providers |
| | are Commercial, Medicaid (or Public Assistance), |
| | Medicare, Managed Care, Worker's Compensation, |
| | and Self-Pay. There are usually some additional |
| | financial class codes for specific types of insurance |
| | coverage. |
| Patient Types | This file contains the patient type codes and their |
| | descriptions. The codes are usually inpatient, |
| | outpatient, and emergency. |
| Transaction Codes | This file contains the transaction codes and their |
| | mnemonics as used by the provider. The codes for |
| | financial transactions generally relate to how those |
| | financial transactions will be grouped for reporting |
| | purposes. For example, insurance adjustments may |
| | be for a contractual allowance (a negotiated |
| | discount) or for a non-covered service (a |
| | potentially avoidable loss of revenue). Transaction |
| | codes for denials are more fully described in table |
| | 2.1 which follows. |
| Clinical Service | The file contains the clinical service location code |
| Locations | and its description. The clinical service locations |
| | are departments, or sub-departments, within the |
| | provider setting. This information is used by the |
| | invention to identify which areas, and their |
| | associated data gathering activities, are performing |
| | better or worse than other areas. |
| Claim Status Codes | These codes represent the coded responses |
| and associated | provided by insurance plans to the provider to |
| insurance payer | explain why a claim was not paid, partially paid, or |
| identification | payment was permanently denied. While there are |
| | over 100 standard codes for Medicare, most other |
| | insurance plans use their own set of codes. Some |
| | providers enter these codes as adjustments. Other |
| | providers just make a freeform note on the account |
| | to reflect the receipt of this denial information from |
| | the payer. |
| | In those instances where the denial information is |
| | recorded via freeform text entries, the invention |
| | searches the freeform entries and executes its |
| | pattern matching algorithm to determine the denial |
| | information which has been received, and generates |
| | a denial transaction code for processing by the |
| | invention. |
| | Sub-Table 2.1, which follows, contains a more |
| | detailed description of how the denials are |
| | determined from the freeform text search and how |
| | they are then summarized to the intermediate |
| | summary form used for reporting. |

SUB-TABLE 2.1

| | |
|---|---|
| Denial intermediate summary classifications | Applicable Denial mnemonics on a denial |
| | transaction extracted from the payer, or text string |
| | matches determined by searching the freeform |
| | comments manually entered for this patient. Note |
| | that the text string searches look for abbreviations |
| | as well as accurate spellings. |
| Claim Issue - all of the denials which indicate an | Accident, insurance card, ins card, error, lacks info, |
| error on the claim submitted; e.g., a newborn | missing hcpc, subscr edt, timely filing, cannot id |
| delivery but the patient's sex was male. | the patient, duplicate claim, liability insurance |
| | should cover, invalid code, invalid date, |
| Not Eligible - all of the denials which indicate that | Alpha, COBRA, denied, no auth, no precert, not |
| the patient was not eligible for coverage from this | approved, not apprv, not elig, pre exist, rejectred, |
| payer | rej., reject, same date, expenses incurred outside of |
| | coverage period, premium not paid, not an |
| | emergency service, not workcomp, coverage |
| | terminated, tim filing, timely filing, time limit, |
| | patient not insured, dependent not covered |
| Non-Covered - all of the denials which indicate | Benefits exhausted, non cov, not cov, non covered, |
| that some or all of the clinical services provided | not covered, not medically necessary |
| were not covered by the patient's insurance | |
| Coordination of Benefits (COB) - all of the denials | COB - another insurance must pay before this |
| which indicate that the insurance plan believes that | payer will pay any remaining unpaid covered |
| the patient has separate insurance coverage which | charges. |
| should pay for these clinical services, and that the | |
| payer issuing this denial will then pay for any | |
| remaining unpaid services validly covered by this | |
| payer | |
| Patient Information Required - all of the denials | Addl info, add info, charity, student, accident info |
| which indicate that the payer needs some additional | needed, onset of illness may be outside of covered |
| information before it can adjudicate this claim, and | period |
| that this type of information must be obtained from | |
| the patient | |
| Provider Review Required - all of the denials | Ret mail, return mail, and all other payer denial |
| which cannot otherwise be specifically classified. | mnemonics which are not otherwise matched above |
| These denials generally require research on the | fall into this general review classification, copy of |
| account to determine what actions are needed to | medical record required |
| obtain final adjudication of the claim by the payer | |
| Biller Activity | The coded entry consists of generating a |
| | transaction code including “BI-” to indicate biller |
| | activity and then either the initials or an |
| | abbreviated name for this person. The fields are |
| | derived by searching freeform text comments for |
| | indicative words or abbreviations and by examining |
| | claim generation histories. |
| Account Follow-up Activity | The coded entry consists of generating a |
| | transaction code including “FU-” to indicate |
| | Follow-Up activity and then either the initials or an |
| | abbreviated name for this person. The fields are |
| | derived by searching freeform text comments for |
| | indicative words or abbreviations and by examining |
| | the date of these entries. The most common |
| | indicators refer to placing calls to payers or |
| | patients. Also, as a practical matter, the majority of |
| | freeform notes on an account after final billing are |
| | attributable to follow-up activity, so the invention |
| | defaults to follow-up activity if it cannot ascertain |
| | that the freeform note recorded another type of |
| | activity. |

### Appendix C

TABLE 3

| Payment Activity Summarizations | Description of how the data is generated |
|---|---|
| Determination of which insurance or patient the | As referred to in sub-Table 2.1, an algorithm has |
| payment activity represents. | been applied to determine whether the payment is |
| | an insurance payment or a patient payment. If an |
| | insurance payment, the assignment of a 1, 2, or 3 |
| | was determined to indicate the Coordination of |
| | Benefits sequence for this payment. For each |
| | payment summarization presented in the following |
| | rows in this Table 3, the payment has been aligned |
| | and accumulated by the appropriate insurance COB |
| | and for patient payments. |
| The patient number for this/these payment(s) | The patient account number |
| If an insurance payment, the insurance plan COB | COB entry of 1-4, with 4 being patient payment. |
| sequence as previously determined | |
| The effective date of the first, if any, payment | |
| The amount of the first, if any, payment | |
| The effective date of the last, if any, payment | |
| The total amount of all, if any, payments | |
| The total number of different dates on which a | |
| payment was posted to this account for this | |
| insurance COB or patient payment | |

### Appendix D

TABLE 4

| Adjustment Activity Summarizations | Description of how the data is generated |
|---|---|
| Determination of which insurance or patient the | As referred to in sub-Table 2.1, an algorithm has |
| adjustment activity represents. | been applied to determine whether the adjustment |
| | is an insurance adjustment or a patient adjustment. |
| | If an insurance adjustment, the assignment of a 1, |
| | 2, or 3 was determined to indicate the Coordination |
| | of Benefits sequence for this adjustment. For each |
| | adjustment summarization presented in the |
| | following rows in this Table 4, the adjustment has |
| | been aligned and accumulated by the appropriate |
| | insurance COB and for patient adjustments. |
| The patient number for this/these payment(s) | The patient account number |
| If an insurance adjustment, the insurance plan COB | COB entry of 1-4, with 4 being patient adjustment. |
| sequence as previously determined | |
| The effective date of the first, if any, adjustment | |
| The amount of the first, if any, adjustment | |
| The effective date of the last, if any, adjustment | |
| The total amount of all, if any, adjustments | |
| The total number of different dates on which an | |
| adjustment was posted to this account for this | |
| insurance COB or patient adjustment | |

### Appendix E

TABLE 5

| Payer Generated Claim Status (Denial) Information | Description of how the data is generated |
|---|---|
| Determination of which insurance the denial | As referred to in Table 2.1, an algorithm has been |
| represents. | applied to determine the assignment of a 1, 2, or 3 |
| | to indicate the Coordination of Benefits sequence |
| | for this denial. For each denial summarization |
| | presented in the following rows in this Table 5, the |
| | denial has been aligned and accumulated by the |
| | appropriate insurance or patient denial sequence. |
| The patient number for this/these denial(s) | |
| The insurance plan COB sequence as previously | |
| determined | |
| The effective date of the first, if any, denial | |
| The amount of the first, if any, denial | |
| The effective date of the last, if any, denial | |
| The total amount of all, if any, denials | |
| The total number of different dates on which a | |
| denial was posted to this account for this insurance | |
| COB or patient denial | |

Note:
a description of each of these claim status values and how they are summarized has been previously described and can be found in Table 2.1.

### Appendix F

TABLE 6

| | |
|---|---|
| Activity Generated by Billing Personnel on an | As previously described in sub-table 2.1, the |
| account | determination that a Biller has worked on the |
| | account is made by either referencing the user roles |
| | table or by examining the freeform text entered to |
| | determine a billing activity has occurred. |
| Determination of which insurance the billing | As described in sub-Table 2.1, an algorithm has |
| activity represents. | been applied to determine the active insurance |
| | claim at the time of the billing activity. In this |
| | way, the COB relevant to this billing activity is |
| | established. Each of the following five rows of |
| | data are summarized in the database for each COB |
| | applicable to the patient. |
| The effective date of the first, if any, billing | |
| activity | |
| The first small segment of the follow-up note for | |
| the first billing activity, if any | |
| The effective date of the last, if any, billing activity | |
| The last small segment of the follow-up note for | |
| the first billing activity, if any | |
| The total number of different dates on which a | |
| billing activity was posted to this account for this | |
| insurance COB. | |

### Appendix G

TABLE 7

| | |
|---|---|
| Activity Generated by Follow-up Personnel on an | As previously described in sub-table 2.1, the |
| account | determination that Follow-up personnel have |
| | worked on the account is made by either |
| | referencing the user roles table or by examining the |
| | freeform text entered to determine that follow-up |
| | activity has occurred. |
| Determination of which insurance the follow-up | As described in sub-Table 2.1, an algorithm has |
| activity represents. | been applied to determine the active insurance |
| | claim at the time of the follow-up activity. In this |
| | way, the COB relevant to this follow-up activity is |
| | established. Each of the following five rows of |
| | data are summarized in the database for each COB |
| | applicable to the patient. |
| The effective date of the first, if any, follow-up | |
| The first small segment of the follow-up note for | |
| the first follow-up, if any | |
| The effective date of the last, if any, follow-up | |
| The last small segment of the follow-up note for | |
| the last follow-up, if any | |
| The total number of different dates on which | |
| follow-up activity was posted to this account for | |
| this insurance COB. | |

### Appendix H

TABLE 8

| Data fields generated to convey meaning as to the | |
|---|---|
| payment status of a claim for each insurance plan | |
| coverage applicable to this patient's episode of | |
| care, and on the overall account status | Description of how the data is generated |
| Balance Type | Identifies the account balance as Debit, Zero, or |
| | Credit |
| Balance % | For Debit balance accounts, calculate the % the |
| | balance represents of the total charges on the |
| | account |
| Ins-1 PIF | A Y/N indicator as to whether the primary |
| | insurance has paid in full (PIF) or not. The |
| | approach first examines the total adjustments for |
| | this insurance plan and calculates the total amount |
| | of payment possible from the insurance plan. The |
| | percentage that the total payments to date represent |
| | of this total possible payment amount is then |
| | calculated. If the percentage paid is greater than |
| | 80% of the total potential payment and the patient |
| | accounting system indicates that the insurance has |
| | been paid, then the insurance is considered to have |
| | paid in full |
| Ins-1 PIF Date | The PIF date is the date of the last payment for a |
| | PIF insurance. |
| Ins-1 Pd % | The Paid % is the percentage the payment |
| | represents of the total charges on the account. Note |
| | that this is different than the percentage used to |
| | determine whether PIF had been achieved or not. |
| Ins-2 PIF | Similar to the Ins-1 PIF determination above with |
| | the following additions. The maximum expected |
| | payment for Ins-2 is the result after taking into |
| | account all ins-1 payments and adjustments, as well |
| | as the ins-2 adjustments. |
| Ins-2 PIF Date | The PIF date is the date of the last payment for a |
| | PIF insurance. |
| Ins-2 Pd % | The Paid % is the percentage the payment |
| | represents of the total charges on the account. Note |
| | that this is different than the percentage used to |
| | determine whether PIF had been achieved or not. |
| Secondary Insurance Exists | A Y/N indicator for whether the patient has more |
| | than one insurance plan |
| Balance Due From Which Payment Source | A generated value to indicate the type of payment |
| | source currently responsible for the account |
| | balance. The values are primary insurance, |
| | secondary insurance, the patient when there was |
| | never insurance coverage, and the patient after |
| | insurance(s) has paid. The algorithm checks |
| | whether secondary insurance exists and checks the |
| | PIF status of all insurances to arrive at the value for |
| | this field. |
| Active Insurance Plan id | In those instances where the balance due is an |
| | insurance responsibility, this field contains the |
| | insurance plan id for that responsible insurance |
| | plan |
| Override information for active insurance plan id | In some instances (for example, liability insurance |
| | claims associated with an accident), the provider |
| | will enter a freeform entry to define where the |
| | claim for payment is to be sent. If the active |
| | insurance has had such a freeform entry made, then |
| | this field is populated with that value. |
| Days Discharge to Final Bill for Ins-1 | A calculation of the number of days from discharge |
| | (or date of last service for an outpatient) to the |
| | Final Bill date for the primary insurance |
| Days Final Bill to Ins-1 PIF | In those cases where the primary insurance has PIF, |
| | the number of days are calculated from the Final |
| | Bill date to the date PIF. |
| Days Ins-1 PIF to Ins-2 PIF | In those instances where a secondary insurance |
| | exists and has PIF, the number of days from the |
| | primary PIF to the date of the secondary PIF |
| Claim Submission Timing Grouping | This is a summary calculation representing the |
| | number of weeks from discharge until the Final Bill |
| | Date. This summary is used to facilitate |
| | management reporting of this performance measure |
| Claim Payment Timing Grouping | This is a summary calculation representing the |
| | number of months from discharge until the |
| | insurance PIF date. This summary is used to |
| | facilitate management reporting of this |
| | performance measure |
| Date of Last Insurance Financial Transaction | This date is used to assess whether there is active |
| | work being done on an insurance claim or not |
| Date of Last Contact to or from the Insurance Co. | This date is used to assess whether there is active |
| | work being done on an insurance claim or not. The |
| | date is determined by taking the later of the last |
| | denial date, the last billing activity date, or the last |
| | account follow-up date. |
| Total Count of all denial and contact info on the | This total count of denials, billing activity, and |
| account | follow-up activity is generated such that |
| | management information as to how much work has |
| | gone into getting this claim resolved and paid. |

### Appendix I

TABLE 9

| Data generated to convey summary information | |
|---|---|
| and meaning to the various types of re-work | |
| activity which has occurred in the pursuit of | |
| obtaining payment for this insurance claim | Description of how the data is generated |
| Date of last denial | This is the date of the last denial and is determined |
| | by querying the database with these parameters. |
| Days from 1^{st} denial to present date | The number of days are determined from the date |
| | of the first denial posted to the account |
| Days from last denial to present date | The number of days are determined from the date |
| | of the last denial posted to the account. This |
| | information is used to infer whether an account is |
| | being actively worked or not. |
| Days from most recent Biller or Follow-up | The number of days from the latest of either billing |
| representative contact to present date | activity or account follow-up activity. This |
| | information is used to infer whether an account is |
| | being actively worked or not. |
| Number of months from last denial | This calculation of the number of months since the |
| | last denial is generated to provide management |
| | information as to time since the last denial. |
| Number of months from last Biller or Follow-up | This calculation of the number of months since the |
| rep contact | last billing or follow-up activity is generated to |
| | provide management information as to time since |
| | these user actions. |
| Follow-up intensity created by summing the total | This total count of denials, billing activity, and |
| number of contacts for this insurance claim | follow-up activity is generated such that |
| | management information as to how much work has |
| | gone into getting this claim resolved and paid. |

### Appendix J

TABLE 10

| Data generated to identify and quantify | |
|---|---|
| relationships among the various performance data | |
| generated as described in Tables 8 and 9. | Description of how the data is generated |
| Re-Work Summary code, generated by assessing | This field is generated by examining the database |
| various re-work events and the timing of each such | contents for billing activity, follow-up activity, and |
| event. | denial activity. By assessing the various |
| | combinations of these activities, the following |
| | values are created for this field: |
| | None, BI-only, Den-only, Flwp-only, BI&Den, BI |
| | &Flwp, BI &Den &Flwp, or Den &Flwp. (where |
| | BI = billing activity, Den = a denial of any |
| | classification, Flwp = follow-up activity, and None = |
| | none of these activities were posted for this |
| | claim. |
| BI > Den | A Y/N indicator as to whether a billing activity |
| | followed a denial for the primary insurance. |
| BI > Follow-up | A Y/N indicator as to whether a billing activity |
| | followed account follow-up activity for the primary |
| | insurance. |
| Follow-up > Denial | A Y/N indicator as to whether follow-up activity |
| | followed a denial for the primary insurance. |
| Summary of Clinical Locations | This field is used to summarize clinical service |
| | locations to a smaller set to facilitate management |
| | reporting. These summaries are determined on a |
| | provider by provider basis dependent on the patient |
| | volume and on the similarity of administrative |
| | processes among clinical departments (locations). |
| Summary of Insurance plan companies | This field is used to summarize insurance plans to a |
| | smaller set to facilitate management reporting. |
| | These summaries are determined on a provider by |
| | provider basis dependent on the specific insurance |
| | plan volumes and on the similarity of |
| | administrative processes among insurance plans. |
| Identification of “Under/Over payment” PIF | This field contains either a space character or a |
| insurance claims | percentage. A percentage entry indicates a |
| | suspected under/over payment by the payer. This |
| | determination is derived from the primary |
| | insurance payment % as previously described in |
| | Table 8. When that percentage falls outside of a set |
| | amount agreed to by the provider (usually 20%), |
| | the claim is determined to have potentially been |
| | underpaid. |
| Identification of claims which were denied as being | A Y/N indicator generated by examining the |
| Not Eligible, and therefore can never be paid | denials posted to the account which are classified |
| | as Not Eligible denials. |
| Identification of claims which were denied as | A Y/N indicator generated by examining the |
| having Non-Covered charges. These may or may | denials posted to the account which are classified |
| not be legitimate forms of non-payment to the | as Non Covered denials. |
| provider. | |
| Number of days from Final Bill date to the first | This calculation is made using the final bill date |
| Biller Activity seen on the account | and date of first biller activity as posted in the |
| | database. |
| The range of days represented by the number of | The range is divided into one week increments in |
| days in the biller activity days cell immediately | order to facilitate management reporting |
| above | |
| Number of days from Final Bill date to the first | This calculation is made using the final bill date |
| claim Denial Activity seen on the account | and date of first claim denial posted in the database. |
| The range of days represented by the number of | The range is divided into one week increments in |
| days in the denial days cell immediately above | order to facilitate management reporting |
| The revised total payment amount, in those | This revised payment amount is obtained from the |
| instances where there is an “after the fact” | claims reconciliation file, in those instances where |
| adjustment to the payment amount by the insurance | this business practice exists. |
| plan. This amount should be the final payment | |
| made by the insurance plan to the provider. | |
| Biller Activity as “initial billing”. Each provider | Based on specific provider preferences, billing |
| will determine the number of days immediately | activity which occurs shortly after discharge is |
| after patient discharge that they consider to be in | considered initial billing and not re-work. This |
| the timeframe of generating the initial claim form. | field uses that provider setting to determine Y/N as |
| | to whether the Billing activity on this account |
| | should be considered as initial billing or re-work. |
| Small Balance range categories. Each provider will | Ranges are computed, based on provider |
| determine the range of total dollars for “small | preferences, to facilitate management reporting of |
| balance” accounts they desire on management | performance vis-a-vis the relative amount of the |
| reports. The purpose is to be able to analyze | total charges on the account. |
| payment timeliness and payment amounts across | |
| various dollar values of claims generated and paid | |
| or unpaid. | |
| Clean Claim Recap. This field examines all of the | This field's summary outcome values are either: |
| Biller, Denial, and Account Follow-up activities on | Clean Claim (i.e., no biller or follow-up activity, no |
| claims to determine how to summarize the overall | denials posted, and the primary insurance claim as |
| processing steps (re-work) which occurred in order | PIF), Billing only, Follow-up only, Denial only, or |
| to reach final resolution, paid or unpaid, for the | multiple, or, for claims not paid in full, pending |
| claim. | payment. |
| This field indicates whether a denial(s) summarized | A Y/N indicator for the Claim Issue sub- |
| as a “Claim Issue” existed on this claim or not. | classification of denials. |
| This field indicates whether a denial(s) summarized | A Y/N indicator for the Non-Covered Charges sub- |
| as “Non-Covered Charges” existed on this claim or | classification of denials. |
| not. | |
| This field indicates whether a denial(s) summarized | A Y/N indicator for the Patient Not Eligible sub- |
| as a “Patient Not Eligible” existed on this claim or | classification of denials. |
| not. | |
| This field indicates whether a denial(s) summarized | A Y/N indicator for the Coordination of Benefits |
| as a “Coordination of Benefits Issue” existed on | sub-classification of denials. |
| this claim or not. | |
| This field indicates whether a denial(s) summarized | A Y/N indicator for the Additional Information |
| as “Additional Information Required from the | required from the Patient sub-classification of |
| Patient” existed on this claim or not. | denials. |
| This field indicates whether a denial(s) summarized | A Y/N indicator for the provider review required |
| as a “Hospital must review the Claim” existed on | sub-classification of denials. |
| this claim or not. | |
| Targeted Accounts Summary Determination. This | The database is interrogated such that this field |
| field contains the result of examining the financial | takes on the resulting values of: |
| and personal activity recorded on an account to | Primary insurance PIF, and a balance |
| conclude if the account is not being actively | pending |
| worked, or to determine if a claim PIF was paid in | The account in zero balance |
| what appears to be an “underpayment” amount. | The account is being actively worked |
| | Primary insurance disallowed, and balance |
| | still pending |
| | Amount due from insurance, no insurance |
| | payments, and no activity for a period of |
| | time (established by the provider - usually |
| | 40 days) |
| | Amount due from insurance, a partial |
| | insurance payment has been posted, and no |
| | activity for a period of time (established by |
| | the provider - usually 40 days) |

What is claimed is:

1. A method for building a database, comprising:
generating, with a payment status module that is in communication with the database, payment status information for a plurality of insurance claims and a plurality insurance providers based on payment information, wherein the payment information includes an amount paid and payment timing information;
generating, with an activity status module that is in communication with the database, activity status information based on a least one of billing staff activity information, account follow-up staff activity information, and payer feedback information; and
populating the database the payment status information and the activity status information.

2. The method of claim 1 further comprising:
determining, with a payment anomaly module that is in communication with the payment status module, the activity module, and the database, payment anomaly information for each of the plurality of insurance claims based on the payment status information; and
populating the database with the payment anomaly information.

3. The method of claim 2 wherein the payment anomaly information is based on the activity status information.

4. The method of claim 2 wherein the anomaly information indicates an underpaid insurance claim when the amount paid is less than a billed amount and the payment anomaly information indicates an overpaid insurance claim when the amount paid is greater than the billed amount.

5. The method of claim 4 further comprising:
generating, with an underpayment module, an underpayment follow-up procedure when the payment anomaly information indicates the underpaid insurance claim; and
populating the database with the underpayment follow-up procedure.

6. The method of claim 4 further comprising:
generating, with an overpayment module, an overpayment follow-up procedure when the payment anomaly information indicates the overpaid insurance claim; and
populating the database with the overpayment follow-up procedure.

7. The method of claim 3 wherein the payment anomaly information indicates a lost insurance claim when the payment status information and the activity status information remain unchanged for a predetermined time.

8. The method of claim 7 further comprising:
generating, with a lost payment module, a lost follow-up procedure when the payment anomaly information indicates the lost insurance claim; and
populating the database with the lost follow-up procedure.

9. The method of claim 1 further comprising:
determining, with a reworked payment module in communication with the payment status module, the activity module, and the database, which of the plurality of insurance claims have been paid in full based on the amount paid;
determining, with the reworked payment module, time lapse information for each of the plurality of insurance claims paid in full based on a billing date and a payment date;
classifying, with the reworked payment module, each of the plurality of insurance claims as reworked insurance claims based on the time lapse information;
populating the database with reworked insurance claim information for each of the reworked insurance claims.

10. The method of claim 9 further comprising classifying each of the reworked insurance claims into an insurance claim category and determining for each insurance claim category an average time lapse between the billing date and the payment date.

11. The method of claim 10 further comprising ranking each insurance claim category based on the average time lapse.

12. The method of claim 11 further comprising:
determining, with a refused payment module, which of the plurality of insurance claims have been refused payment based on the payment status information and the activity status information; and
populating the database with refused payment information for the plurality of insurance claims that have been refused payment.

13. The method of claim 12 further comprising classifying each of the plurality of insurance claims that have been refused payment into a plurality of refused insurance claim categories.

14. The method of claim 13 further comprising populating the database with the plurality of refused insurance claim categories.

15. A computer readable medium comprising instructions executable by a processor that, when executed, cause the processor to:
generate payment status information for a plurality of insurance claims and a plurality insurance providers based on payment information, wherein the payment information includes an amount paid and payment timing information;
generate activity status information based on at least one of billing staff activity information, account follow-up staff activity information, and payer feedback information; and
populate a database with the payment status information and the activity status information.

16. The computer readable medium of claim 15 wherein the instructions further cause the processor to:
determine payment anomaly information for each of the plurality of insurance claims based on the payment status information; and
populate the database with the payment anomaly information.

17. The computer readable medium of claim 16 wherein the payment anomaly information is based on the activity status information.

18. The computer readable medium of claim 16 wherein the payment anomaly information indicates an underpaid insurance claim when the amount paid is less than a billed amount and the anomaly information indicates an overpaid insurance claim when the amount paid is greater than the billed amount.

19. The computer readable medium of claim 18 wherein the instructions further cause the processor to:
generate an underpayment follow-up procedure when the payment anomaly information indicates the underpaid insurance claim; and
populate the database with the underpayment follow-up procedure.

20. The computer readable medium of claim 18 wherein the instructions further cause the processor to:
generate an overpayment follow-up procedure when the payment anomaly information indicates the overpaid insurance claim; and
populate the database with the overpayment follow-up procedure.

21. The computer readable medium of claim 17 wherein the payment anomaly information indicates a lost insurance claim when the payment status information and the activity status information remain unchanged for a predetermined time.

22. The computer readable medium of claim 21 wherein the instructions further cause the processor to:
generate a lost follow-up procedure when the payment anomaly information indicates the lost insurance claim; and
populate the database with the lost follow-up procedure.

23. The computer readable medium of claim 15 wherein the instructions further cause the processor to:
determine which of the plurality of insurance claims have been paid in full based on the amount paid;
determine time lapse information for each of the plurality of insurance claims paid in full based on a billing date and a payment date;
classify each of the plurality of insurance claims as reworked insurance claims based on the time lapse information;
populate the database with reworked insurance claim information for each of the reworked insurance claims.

24. The computer readable medium of claim 23 wherein the instructions further cause the processor to classify each of the reworked insurance claims into an insurance claim category and determining for each insurance claim category an average time lapse between the billing date and the payment date.

25. The computer readable medium of claim 24 wherein the instructions further cause the processor to rank each insurance claim category based on the average time lapse.

26. The computer readable medium of claim 15 wherein the instructions further cause the processor to:
determine which of the plurality of insurance claims have been refused payment based on the payment status information and the activity status information; and
populate the database with refused payment information for the plurality of insurance claims that have been refused payment.

27. The computer readable medium of claim 26 wherein the instructions further cause the processor to classify each of the plurality of insurance claims that have been refused payment into a plurality of refused insurance claim categories.

28. The computer readable medium of claim 27 wherein the instructions further cause the processor to populate the database with the plurality of refused insurance claim categories.

29. A revenue cycle system, comprising:
a payment status module that is operative to provide payment status information for a plurality of insurance claims and a plurality insurance providers based on payment information that includes an amount paid and payment timing information and to populate the payment status information in a database; and
an activity status module that is operative to provide activity status information based on a least one of billing staff activity information, account follow-up staff activity information, and payer feedback information and to populate the activity status information in the database.

30. The revenue cycle system of claim 29 further comprising a payment anomaly module that is operative to determine payment anomaly information for each of the plurality of insurance claims based on the payment status information.

31. The revenue cycle system of claim 30 wherein the payment anomaly information is based on the activity status information.

32. The revenue cycle system of claim 30 wherein the payment anomaly information indicates an underpaid insurance claim when the amount paid is less than a billed amount and the anomaly information indicates an overpaid insurance claim when the amount paid is greater than the billed amount.

33. The revenue cycle system of claim 32 further comprising an underpayment module that is operative to generate an underpayment follow-up procedure when the payment anomaly information indicates the underpaid insurance claim.

34. The revenue cycle system of claim 32 further comprising an overpayment module that is operative to generate generating an overpayment follow-up procedure when the payment anomaly information indicates the overpaid insurance claim.

35. The revenue cycle system of claim 31 wherein the payment anomaly information indicates a lost insurance claim when the payment status information and the activity status information remain unchanged for a predetermined time.

36. The revenue cycle system of claim 35 further comprising a lost payment module that is operative to generate a lost follow-up procedure when the payment anomaly information indicates the lost insurance claim.

37. The revenue cycle system of claim 29 further comprising a reworked payment module that is operative to:
determine which of the plurality of insurance claims have been paid in full based on the amount paid;
determine time lapse information for each of the plurality of insurance claims paid in full based on a billing date and a payment date; and
classify each of the plurality of insurance claims as reworked insurance claims based on the time lapse information.

38. The revenue cycle system of claim 37 wherein the reworked payment module is operative to classify each of the reworked insurance claims into an insurance claim category and determine for each insurance claim category an average time lapse between the billing date and the payment date.

39. The revenue cycle system of claim 38 wherein the reworked payment module is operative to rank each insurance claim category based on the average time lapse.

40. The revenue cycle system of claim 29 further comprising a refused payment module that is operative to determine which of the plurality of insurance claims have been refused payment based on the payment status information and the activity status information.

41. The revenue cycle system of claim 40 wherein the refused payment module is operative to classify each of the plurality of insurance claims that have been refused payment into a plurality of refused insurance claim categories.

42. A computer readable medium having stored thereon a data structure, comprising:
a plurality of first data fields representing payment status information for a plurality of insurance claims and a plurality insurance providers, wherein the payment status information is based on payment information that includes an amount paid and payment timing information;
a second data field representing payment activity information that is based on at least one of billing staff activity information, account follow-up staff activity information, and payer feedback information.

43. The computer readable medium of claim 42 further comprising a third data field representing payment anomaly information that is based on the payment status information.

44. The computer readable medium of claim 43 wherein the payment anomaly information is based on the activity status information.

45. The computer readable medium of claim 43 wherein the payment anomaly information represents an underpaid insurance claim when the amount paid is less than a billed amount and the anomaly information represents an overpaid insurance claim when the amount paid is greater than the billed amount.

46. The computer readable medium of claim 45 further comprising a fourth data field representing underpayment information when the payment anomaly information indicates the underpaid insurance claim.

47. The computer readable medium of claim 45 further comprising a fourth data field representing overpayment information when the payment anomaly information indicates the overpaid insurance claim.

48. The computer readable medium of claim 44 wherein the payment anomaly information indicates a lost insurance claim when the payment status information and the activity status information remain unchanged for a predetermined time.

49. The computer readable medium of claim 48 further comprising a fourth data field representing lost payment information when the payment anomaly information indicates the lost insurance claim.

50. The computer readable medium of claim 42 further comprising a third data field representing reworked payment information that is determined by:
determining which of the plurality of insurance claims have been paid in full based on the amount paid;
determining time lapse information for each of the plurality of insurance claims paid in full based on a billing date and a payment date; and
classifying each of the plurality of insurance claims as reworked insurance claims based on the time lapse information.

51. The computer readable medium of claim 50 further comprising a fourth data field representing a classification of each reworked insurance claim and an average time lapse between the billing date and the payment date for each of the reworked insurance claims.

52. The computer readable medium of claim 51 further comprising a fifth data field ranking each insurance claim category based on the average time lapse.

53. The computer readable medium of claim 42 comprising a third data field representing refused payment information that is determined by determining which of the plurality of insurance claims have been refused payment based on the payment status information and the activity status information.

54. The computer readable medium of claim 53 further comprising a fourth data field representing a classification of each of the plurality of insurance claims that have been refused payment.
